(19) United States
(12) Patent Application Publication
(10) Pub. No.: US 2015/0020743 A1
(43) Pub. Date: Jan. 22, 2015

(54) PET LITTER BOX

(71) Applicants: Rhonda Bauer, Broomfield, CO (US); Michael Langston McDowell, Breckenridge, CO (US)

(72) Inventors: Rhonda Bauer, Broomfield, CO (US); Michael Langston McDowell, Breckenridge, CO (US)

(21) Appl. No.: 14/480,817

(22) Filed: Sep. 9, 2014

Related U.S. Application Data
(63) Continuation-in-part of application No. 13/235,291, filed on Sep. 16, 2011, now abandoned.
Application No. 13/235,291 is a continuation-in-part of application No. 12/565,040, filed on Sep. 23, 2009, now abandoned.

(51) Int. Cl. A01K 1/01; A01K 1/015

(52) U.S. Cl. CPC A01K 1/0114; A01K 1/0151
USPC 119/166

(57) ABSTRACT

The invention is directed to a pet litter box that has a lower portion shell assembly and an upper portion shell. The upper portion shell assembly includes an opening onto a grate floor which a pet has to walk across to gain access to the litter below in the lower portion shell. The grate floor and an associated dividing wall are couple directly to and with the upper portion shell such that when the upper portion is removed from the lower portion shell, the grate floor and dividing wall are removed with it giving full access to the litter below. The grate floor is typically comprised of an expanded metal grate.

### RELATED APPLICATIONS

This application is a continuation-in-part of and claims priority on U.S. patent application Ser. No. 13/235/291, entitled “Pet Litter Box” filed Sep. 16, 2011, which in turn is a continuation-in-part of and claims priority on U.S. patent application Ser. No. 12/565,040, entitled “Pet Litter Box” filed Sep. 23, 2009.

### BACKGROUND OF THE INVENTION

It is common for cat owners to have a litter box in their house. The simplest litter box is a shallow rectangular box that holds the litter. Some owners use a plastic bag to encase the litter box. The plastic bag keeps the box clean and facilitates throwing out the used litter. However, this system does not keep other pets such as dogs from snacking or prevent the cat from tracking litter out of the box. Enclosed litter boxes have been produced and this helps to eliminate snacking, but does not prevent litter tracking. There have also been attempts to provide grates in litter boxes to prevent tracking. However, all these previous solutions have not prevented tracking because the cat just jumps over the grate, thereby defeating its purpose or the grate is just too short to be effective or the grate is contained in the lower section and the cat just steps out.

Another common problem with enclosed litter boxes is that some cats do not squat to urinate and the urine runs down the side walls and when it meets the junction between the upper and lower parts of the enclosure it seeps through the horizontal lips or grooves between and runs along the outside wall of the enclosure. This results in urine leaking on the floor. It has also been found that these enclosed litter boxes do not provide a substantial benefit in the reduction of odor from open litter boxes.

### BRIEF SUMMARY OF INVENTION

A pet litter box that overcomes at least some of these problems is described in relation to a first embodiment. The first embodiment has a lower portion having a bottom wall and four lower portion side walls that are at slightly more than ninety degrees from the bottom wall. An upper portion has a top wall and four upper portion side walls. A cutout portion in one of the four upper portion side walls forms a pet ingress and egress point. The four upper side walls terminate in a vertical groove that mates with a lip formed by the four lower portion side walls. An internal divider has a floor grate that extends along a length of the lower portion and a wall. The wall does not extend the length of the lower portion. A divider groove mates with the lip of the lower portion, whereby a pet entering or exiting the pet litter box is required to make a turn on the grate. Forcing a cat to make a turn when exiting the litter box makes sure the cat does not just jump over the grate. This ensures that most of the litter on the cat's paws is removed while jumping onto the grate floor and walking along the grate floor. Also having the grate run along the length of the litter box forces the cat to take several steps on the grate before exiting.

The upper portion and internal divider of the first embodiment litter box can be nested inside the lower portion for easy shipping. The lower portion has a height that is equal to or greater than the upper portion and is about the height of an average cat's head. The upper portion and grate floor bar dogs from snacking. Overlapping edges formed by vertical lips between the upper and lower portions of the litter box stops urine leaks.

A second embodiment pet litter box shares several of the features of the first embodiment but includes different construction that facilitates ease of use by a cat as well as ease of cleaning and maintenance by the pet caretaker. Notably, the grate floor, which is comprised of expanded metal having a side wall slanted relative to vertical, is coupled directly to the upper portion of the box. To access the litter contained in the lower half for scooping and/or changing, the caretaker removes the upper portion, which includes the grate floor and divider wall thereby giving complete and full access to the litter in the lower portion.

### BRIEF DESCRIPTION OF THE SEVERAL VIEWS OF THE DRAWINGS

FIG. 1 is a top left perspective view of a pet litter box in accordance with one embodiment of the invention;

FIG. 2 is an exploded view of the pet litter box in accordance with one embodiment of the invention;

FIG. 3 is a top left perspective view of the pet litter box nested for shipping in accordance with one embodiment of the invention;

FIG. 4 is a side view of a cat;

FIG. 5 is a top view of a portion of a floor grate in accordance with one embodiment of the invention;

FIG. 6 is a cutaway view of the floor grate of FIG. 5, in accordance with one embodiment of the invention;

FIG. 7 is a side view section of the floor grate in accordance with one embodiment of the invention;

FIG. 8 is a cutaway view of the vertical lips of the pet liter box in accordance with one embodiment of the invention; and

FIG. 9 is a cutaway view of a hinge in accordance with one embodiment of the invention.

FIG. 10 is an exploded perspective view of a second embodiment litter box.

FIG. 11A is a front/left side perspective view of the upper portion of the second embodiment litter box.

FIG. 11B is a partial top view of the upper portion of the second embodiment litter box.

FIG. 12A is a front/bottom side perspective view of the upper portion of the second embodiment litter box.

FIG. 12B is a bottom view of the upper portion of the second embodiment litter box.

FIG. 13A is a closeup partial perspective view of the upper portion showing a connection between the floor grate frame and the upper portion according to the second embodiment of the present invention.

FIG. 13B is a closeup partial perspective view of the upper portion showing another connection between the floor grate frame and the upper portion proximate the door according to the second embodiment of the present invention.

FIG. 14A is a cutaway perspective of the upper portion showing the dividing wall according to the second embodiment of the present invention.

FIG. 14B is a cutaway side view showing the dividing wall removed from the upper portion according to the second embodiment of the present invention.

FIG. 15A is a perspective top view of the grate floor and grate floor framework according to the second embodiment of the present invention.

FIG. 15B is a partial closeup perspective top view of the grate floor and grate floor framework according to the second embodiment of the present invention.

FIG. 16A is a closeup partial perspective view of the second embodiment litter box illustrating the door opening.

FIG. 16B is a partial perspective view of the expanded metal grate floor according to the second embodiment of the present invention.

FIG. 17 is an exploded perspective top view of the grate floor and grate floor framework according to the second embodiment of the present invention.

FIG. 18A is a cross sectional view of the expanded metal grate floor according to the second embodiment of the present invention.

FIG. 18B is a perspective top view of a section of the grate floor according to the second embodiment of the present invention.

### DETAILED DESCRIPTION OF THE INVENTION

### A First Embodiment Pet Litter Box

The first embodiment is directed to a pet litter box that has a lower portion having a bottom wall and four lower portion side walls that are at slightly more than ninety degrees from the bottom wall. An upper portion has a top wall and four upper portion side walls. A cutout portion in one of the four upper portion side walls forms a pet ingress and egress point. The four upper side walls terminate in a groove that mates with a lip formed by the four lower portion side walls. An internal divider has a floor grate that extends along a length of the lower portion and has a wall at approximately ninety degrees to the floor grate. The wall does not extend the length of the lower portion. A divider groove mates with the lip of the lower portion, whereby a pet entering or exiting the pet litter box is required to make a turn on the grate. Forcing a cat to make a turn when exiting the litter box makes sure the cat does not just jump over the grate. This ensures that most of the litter on the cat's paws is removed while jumping onto the grate floor and walking along the grate floor. Also having the grate run along the length of the litter box forces the cat to take several steps on the grate before exiting.

The upper portion and internal divider of the litter box can be nested inside the lower portion for easy shipping. The lower portion has a height that is equal to or greater than the upper portion and is about the height of an average cat's head. The upper portion and grate floor bar dogs from snacking. Overlapping edges between the upper and lower portions of the litter box stops urine leaks.

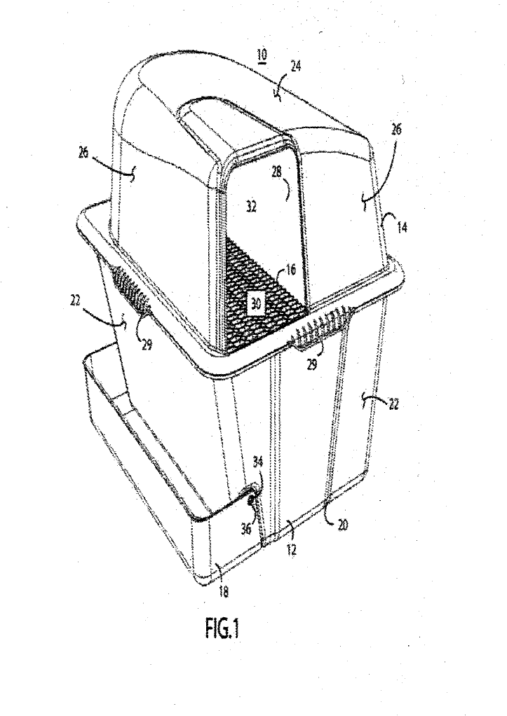

FIG. 1 is a top left perspective view of a pet litter box 10 in accordance with one embodiment of the invention. The litter box 10 has a relatively deep lower portion 12, a removable upper portion 14, an internal divider 16, and a storage shelf 18. The lower portion 12 has a bottom wall 20 and four upper portions side walls 22. The side walls 22 are angled at slightly more that ninety degrees from the bottom wall 20. The upper portion 14 has a top wall 24 and four upper side walls 26. The four upper side walls 26 are not perpendicular to the top wall 24. One of the four upper side walls 26 having an opening or cutout 28. The upper portion 14 has a plurality of handles 29. An internal divider 16 has a floor grate 30 that runs the length of the lower portion 12 and is adjacent to the opening 28. Note that the lower portion side walls 22 form a rectangular opening with a length and width. The internal divider 16 has an internal wall 32 that is perpendicular to the floor grate 30 and does not extend the complete length of the lower portion 12 or the upper portion 14. The wall 32 abuts the upper portion 14 to create a passageway. Where the wall 32 ends it creates a second opening from the floor grate 30 passageway into the lower portion 12. In one embodiment, the litter box 10 has a storage shelf 18. The storage shelf 18 has a plurality of openings 34 that snap fit onto a plurality of tabs 36 on the lower portion 12.

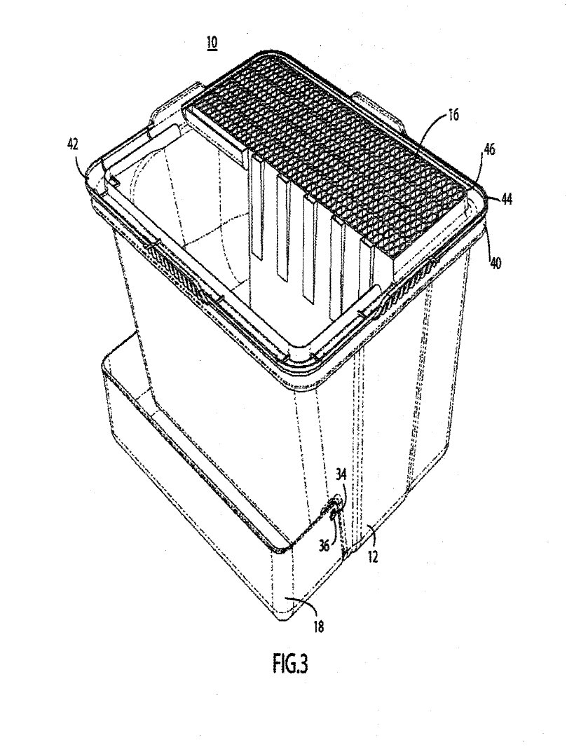

Note that the lower portion 12 has a height (h.sub.L) and the upper portion 14 has a height (h.sub.L) which is equal to or less than the lower portion height. This aides in the nesting of the two portions as seen in FIG. 3. But more importantly it ensures that cats that do not squat to urinate, often called “high pee-ers”, are not able to pee on the upper portion 14. This reduces the time and effort necessary to clean the litter box. Another advantage of the taller lower portion is that it traps the odors associated with the litter box better than enclosed litter boxes with short lower portions since air circulation is restricted. In one embodiment, the height of the lower portion 12 is higher than the average height (h.sub.C) of a cat's head (see FIG. 4). In another embodiment, the lower portion height is at least eight inches. In yet another embodiment, the lower portion height is at least ten inches.

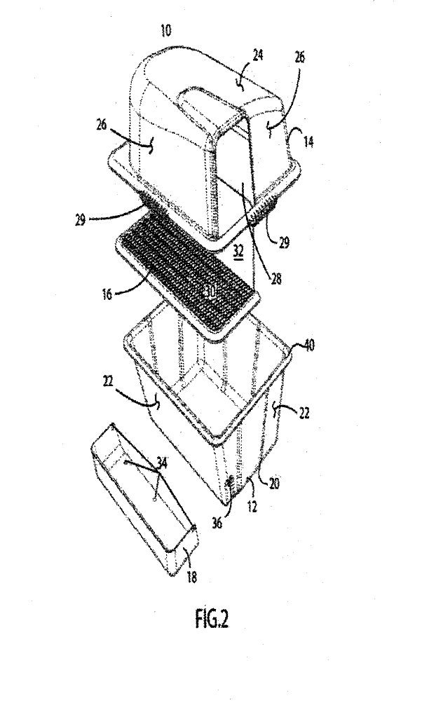

FIG. 2 is an exploded view of the pet litter box 10 in accordance with one embodiment of the invention. This view shows the lower portion 12 is a somewhat rectangular box with obtuse walls 22. The walls 22 terminate in a vertical lip 40 along the periphery of the walls 22. The upper portion 14 has a grove 42 (see FIG. 3) along part of a periphery and half grove or lip 44 along the rest of the periphery that mates with the lip 40 of the lower portion 12. The divider portion 16 includes a step 46 along its periphery. The step 46 and the half groove 44 form a full groove that mates with the lip 40 of the lower portion.

In one embodiment, the litter box 10 has a hinge 47 attaching one of the four lower portion side walls 22 to one of the four upper portion side walls 26. This hinge 47 is shown on the wall opposite of the grate 16, but it could be on any of the walls. The hinge allows for easy access to the litter box. This is particularly helpful with daily excrement removal.

In another embodiment, the upper portion 26 is split in half with a hinge at the top. This allows access to clean the litter box 10. In one embodiment, the grate 30 snap fits to the upper portion 26.

In one embodiment, the lower portion 12 is made of an antimicrobial or antibacterial material, such as a plastic embedded with silver particles. In another embodiment, the upper portion 14 is also made of an antimicrobial or antibacterial material. The grate 16 and divider wall 32 may also be made of antimicrobial or antibacterial material,

FIG. 3 is a top left perspective view of the pet litter box 10 nested for shipping in accordance with one embodiment of the invention. This figure shows how the litter box 10 nests for shipping. The upper portion 14 when turned over nests inside the lower portion 12. The divider portion 16 nests inside the upper portion 14.

FIG. 4 is a side view of a cat and is used to illustrate the height of the lower portion 12.

FIG. 5 is a top view of a portion of a floor grate 16 in accordance with one embodiment of the invention. The floor grate 16 is formed of a number of hexagons 52 connected to a series of squares. This structure gently spreads the cat's paws open releasing the kitty litter. The hexagons and squares form a face of the grate 16.

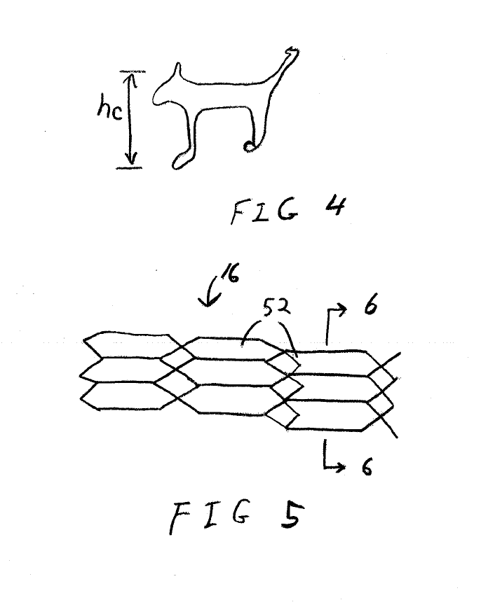

FIG. 6 is a cutaway view of the floor grate of FIG. 5, in accordance with one embodiment of the invention. The walls 54 are not perpendicular to the face of the grate 16. Again this tends to spread the cat's paws and allow kitty litter to release back into the lower portion 22 of the litter box.

FIG. 7 is a side view section of the floor grate 16 in accordance with one embodiment of the invention. This view shows that grate 16 has a grate lip 56 along one of more of its sides that mates with the lower portion vertical lip 40 to hold the grate 16.

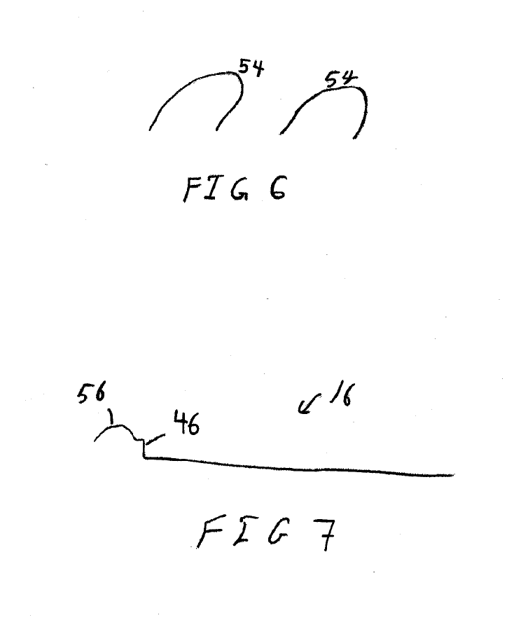

FIG. 8 is a cutaway view of the vertical lips of the pet liter box in accordance with one embodiment of the invention. The lower portion vertical lip 40 mates with the grate vertical lip 56, which mates with vertical lip 44 of the upper portion. Note that if urine happens to hit the upper portion 14 it will be not be able to make it over the grate vertical lip 56, or the lower portion vertical lip 40. As a result, urine is contained inside the litter box. Many previous litter boxes either have horizontal lips and grooves that mate or similar designs that do not provide this advantage. Note that vertical lip means that the lip is pointed up when in normal use.

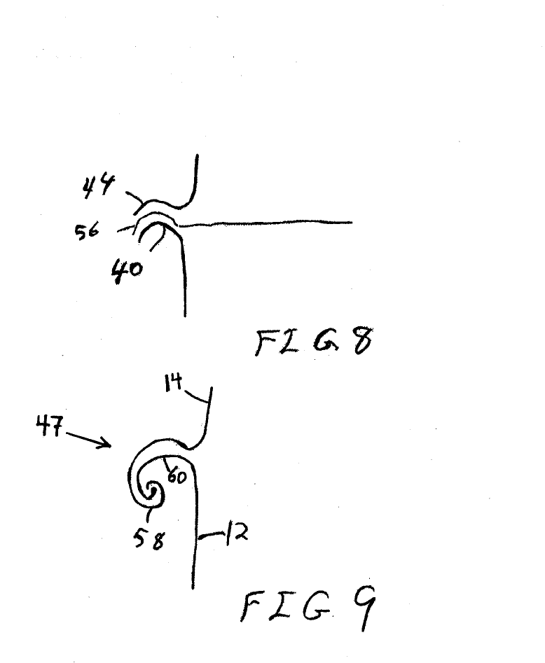

FIG. 9 is a cutaway view of a hinge 47 in accordance with on embodiment of the invention. The hinge 47 in one embodiment does not have an hinge pin. The upper portion 14 has a spiral structure 58 that mates with a spiral structure 60 of the lower portion 12. When the upper portion 14 is rotated up, its spiral structure 58 is captured in the spiral structure 60 of the lower portion. Note that the invention is not limited to this type of hinge and any hinge may be used with the invention.

In one embodiment, the handles 29 on the upper portion 14 mate with the lower portion in a manner similar to that shown in for the hinge 47 that is the handles snap fit onto the lower lip 40. This allow the user to grab the handles and move the whole litter box 10.

In operation litter is placed in the lower portion 12, with or without a plastic bag. The divider portion 16 is placed on top of the lip 40 of the lower portion 40. Then the upper portion 14 is placed on the lip 40 of lower portion 12. When a cat or other pet needs to use the litter box, they jump from the floor through the opening 28 onto the grate floor 30. Then they walk along the length of the grate floor 30 until they reach the end of the divider wall 32 and jump through the opening formed by the upper portion 14, the grate floor 30, and the divider wall 32 into the lower portion 12 containing the litter. The cat does their business and then jumps from the lower portion 12 onto the grate floor 30 and walks along the length of the litter box and then out of the opening 28 onto the floor. Note that it is impossible for the cat to jump from the lower portion 12 through opening 28 onto the floor, since the cat is forced to turn a corner. As a result, the cat walks along the grate or screen floor 30 causing litter on the cats paws to come loose and fall through the grate down into the lower portion 12. The grate's structure forces the opening of the cat's paw releasing the trapped kitty litter.

The overlap between the lip 40 of the lower portion 12 and the vertical lips 42 and 44 & 56 formed by the upper portion 14 and the divider wall 16, prevents any urine leakage out of the litter box 10 even if in the unlikely event that a cat is able to urinate on the upper portion 14.

Thus there has been described that stops dog snacking, reduces tracking, stops urine leaks, limits circulation of odor and can be shipped inexpensively.

### A Second Embodiment Pet Litter Box

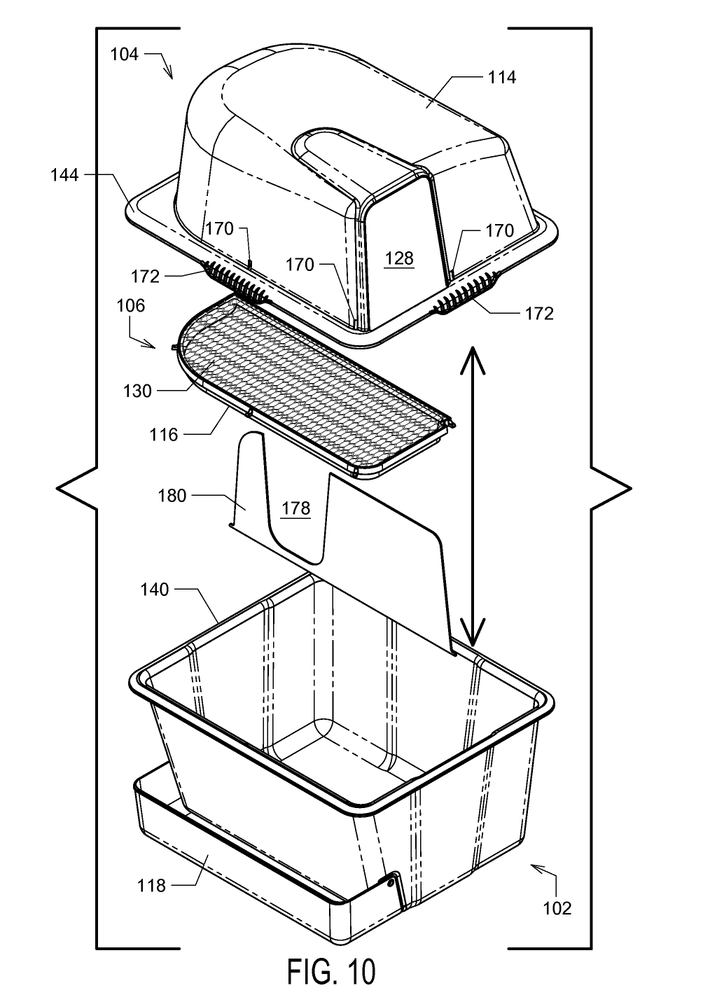

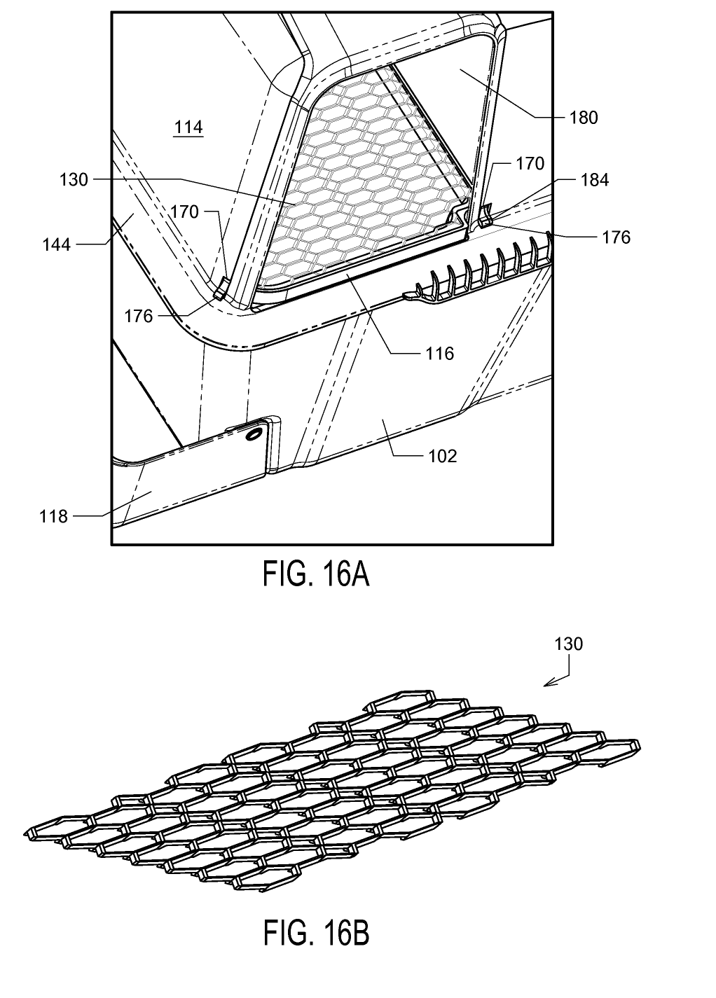

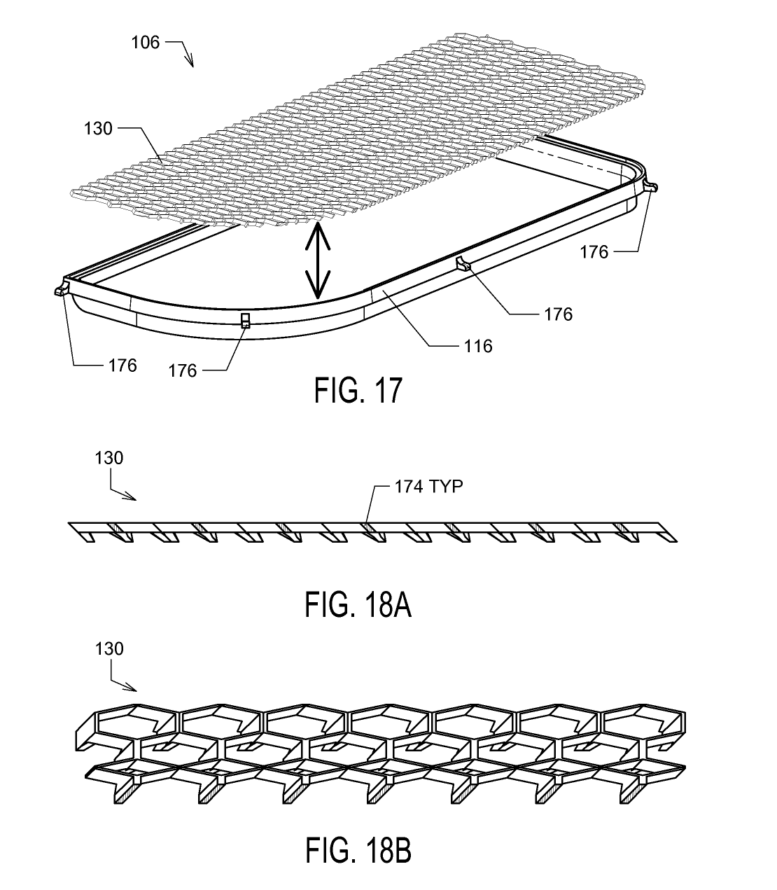

A second embodiment pet litter box 100 is illustrated in FIGS. 10-18. Generally, the box comprises a lower assembly 102 and an upper assembly 104. The lower assembly 102 is substantially similar to the lower portion 12 of the first embodiment in combination with the storage shell 18. It is to be appreciated that the storage shell 118 is optional in the second embodiment and may not be included in all variations thereof. Where no storage shell is included, the lower assembly can also be referred to as the lower portion since it can comprise a single component. The lip 140 of the second embodiment lower portion may differ from the lip of the first embodiment since the lip is not configured to receive the grated floor thereon to be sandwiched between the lips of the upper and lower portions as with the first embodiment. Rather, the lip 140 of the lower assembly 102 is designed to interface directly with a corresponding lip on the upper assembly 104 in an interlocking manner that is well known in the art. For a description of the general configuration and features of the lower assembly 102 reference can be made to the corresponding components of the first embodiment.

The upper assembly 104 although having a similar appearance differs significantly from the first embodiment's upper portion 14. The upper assembly 104 includes: (i) the upper portion shell 114 typically injection molded or otherwise formed from a plastic material; (ii) a grate floor assembly 106 including an expanded metal grate floor 130 received in a grate frame 116; and (iii) a divider wall 180.

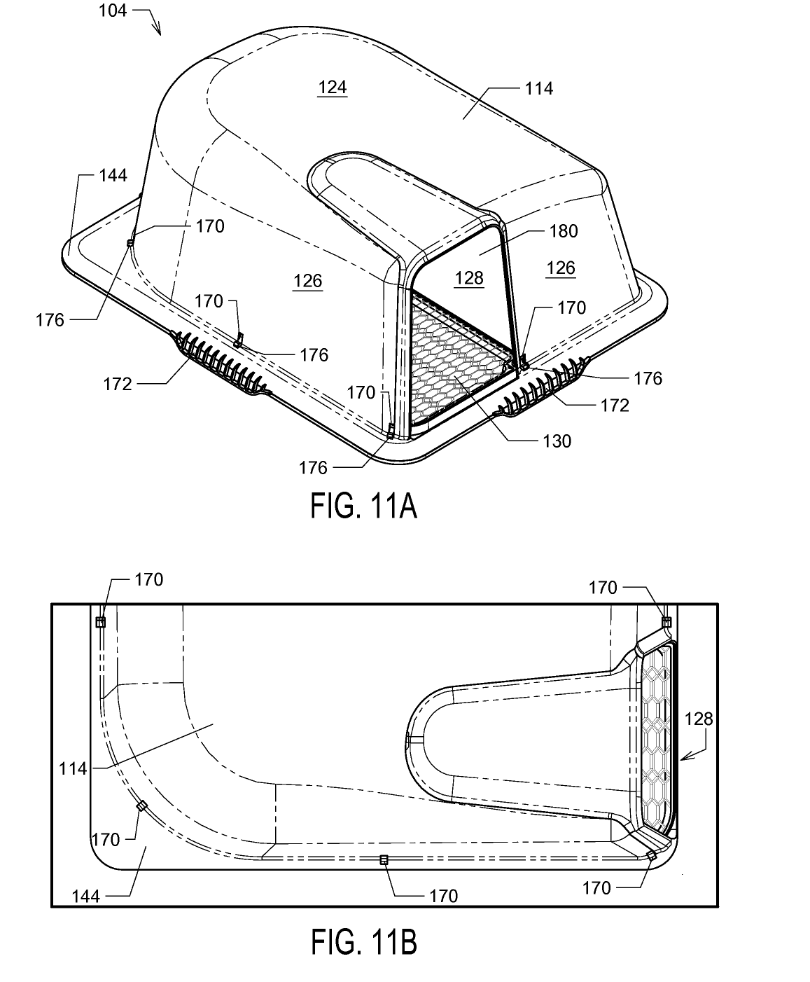

As best shown in FIGS. 11A-14B, The upper portion shell 114 shares similarities with the upper portion 14 of the first embodiment comprising: (i) sidewalls 126 with an entrance opening 128 on one end to permit a pet ingress and egress; (ii) a top wall 124; (iii) a lip 144 extending around the bottom of the upper portion configured to interface with the lip 140 of the lower portion; and (iv) a plurality of small generally rectangular openings 170 distributed along one half of the upper portion just above the lip to receive the grate floor assembly 106. Like the first embodiment upper portion, the lip 144 also includes a plurality of handles 172 molded therein to facilitate removal of the upper portion from the lower portion.

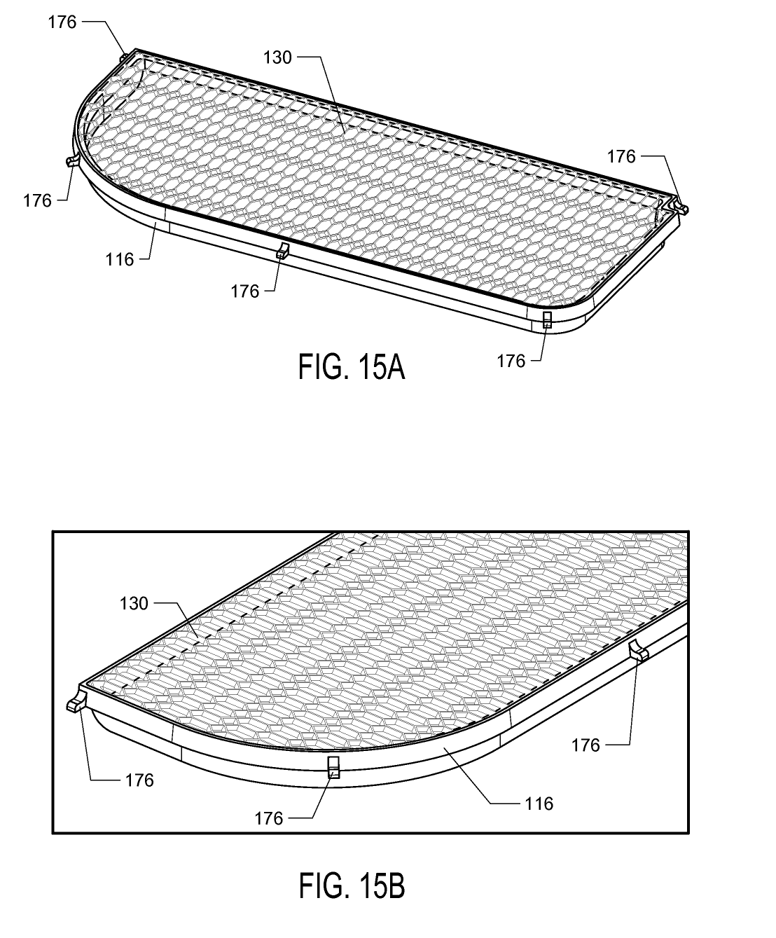

The grate floor 130 is best shown in FIGS. 15, 16, 17 & 18A&B and comprises an expanded metal with sidewalls 174 that are canted off of vertical, and accordingly, are not perpendicular with horizontal. A cross section of the floor is shown in FIG. 18A. Additionally, the top edges of the grating that form the various openings and collectively form the floor surface are not coplanar. Rather, the undulate relative to each other creating a varied surface. The combination of the slanted walls and undulating surface helps spread a pet's paws as it walks across the floor facilitating the release of any litter particles that were caught between the paw pads. The size and pattern associated with the expanded metal sheet used to fabricate the floor can vary depending in part on the size of the pet the litter box is to be used in conjunction with.

The grate floor 130 is received and set in the grate frame 116. The grate frame, which is typically comprised of plastic provides support to all four sides of the grate floor 130 as well as abuts the potentially sharp and rough edges of the expanded metal. The grate floor assembly 106 extends across a portion of the upper portion's opening proximate the lip 144 covering a portion of the litter containing lower portion when the box is assembled. As shown, the grate floor assembly 106 extends from front to back along a longitudinal side of the upper portion. The location of the grate floor assembly can vary but typically does not cover the entirety of the lower portion thereby giving a pet the ability to move in and out of the lower portion by way of the grate floor.

Importantly, the grate frame provides a means for coupling and supporting the grate frame assembly in the upper portion. As best seen in FIGS. 15A & 15B, the frame includes five outwardly projecting appendages 176 that are configured for receipt into five rectangular openings 170. The bottom surfaces of the appendages rest against the bottom edges of a respective rectangular opening 170 effectively securing and supporting the floor assembly. The coupling means can vary as would be obvious to one of ordinary skill in the art to which the invention pertains given the benefit of this disclosure. For instance, generally horizontally-extending slots can be provided in the upper portion into which suitable plate-like appendages that project from the floor frame can be received.

Of significance, the grate floor assembly 106 is secured and attached to the upper portion shell 114 above the lip 144 joining the upper portion with the lip 140 of the lower portion. With this configuration, a user can simply remove the upper portion shell 114 and gain full access to the litter in the lower portion to either scoop it or replace it. Reassembly of the litter box is easier as well compared to the first embodiment as the user does not need to be concerned with the alignment of the grate floor 130 relative to not only the lip 140 of the lower portion shell but also the lip 144 of the upper portion shell.

The final major component of the upper assembly 104 comprises a divider wall 180. The divider wall is typically comprises of a sheet of substantially planar plastic that has been molded, stamped or otherwise formed to conform to the portions of interior shape of the upper portion shell in which it crosses and is received. It effectively separates the interior space of the litter box into two sections: the first section comprising the volume above the grate floor wherein a pet enters and leaves the litter box; and the second section comprises the majority of the volume wherein the pet interfaces with the litter to defecate or urinate.

To permit access between the sections an opening or door 178 is provided in the divider wall. Of significance, the door is provided at a location intermediate of the front and back walls of the upper portion shell 114 but closer to the back wall than the front. The intermediate door location serves several purposes. It requires the pet to enter the first section from the second generally perpendicular to the longitudinal axis of the grate floor and then immediately turn towards the entry door 128 in the upper portion shell. The act of maneuvering and turning as the pet's feet contact the grate helps increase the likelihood that any litter caught between the pads of the pet's feet will be freed and fall back into the lower portion shell assembly 102. The door 178 is located away from the side of the upper portion shell to discourage high peeing cats in particular from peeing near the walls of the shell portions as they might do if they entered the litter from a door located at a sidewall. Because the door is located nearer to the back sidewall, the distance a pet has to walk to exit the box is increased. As the cat steps on the grate floor 130, the undulating surface and the slanted grate floor walls help act to splay the pet's foot pads and permit any litter caught therebetween to fall back into the lower portion without being tracked into a house or other residence in which the pet resides.

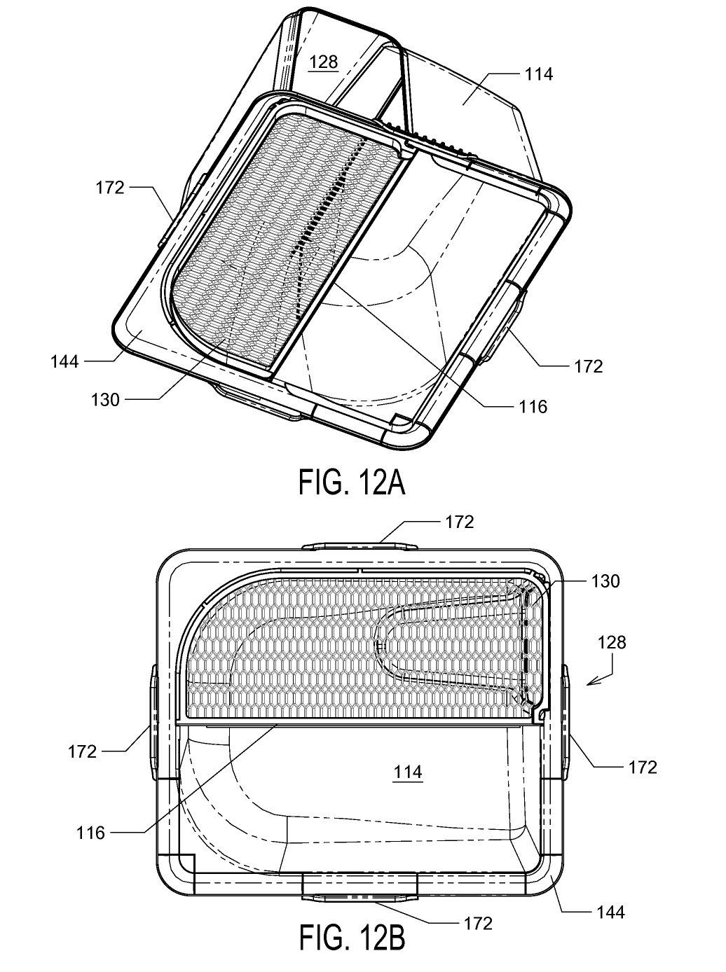

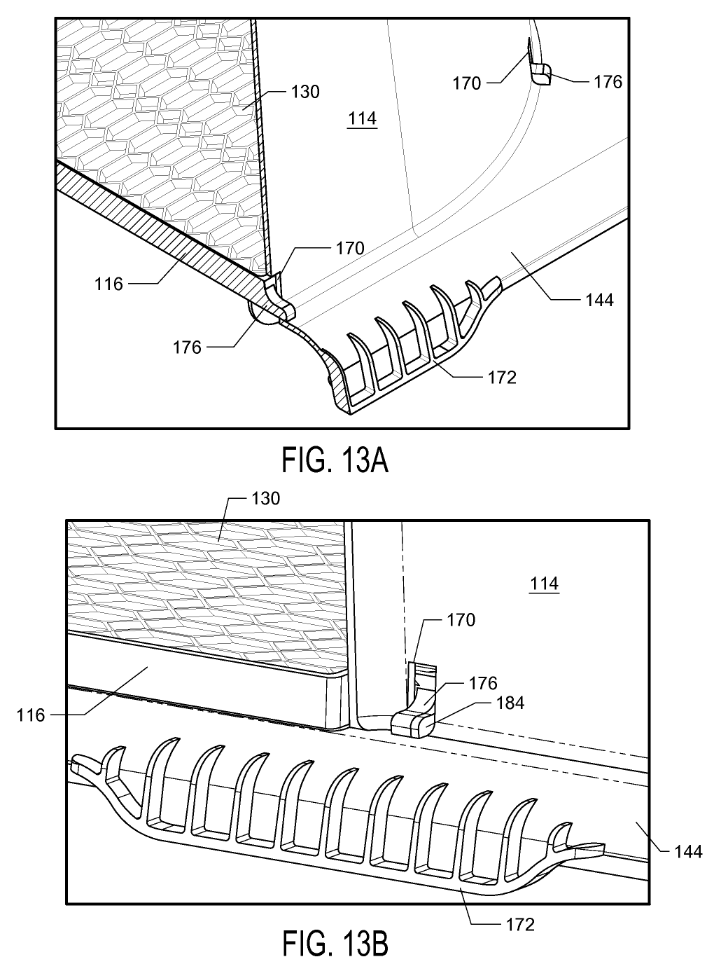

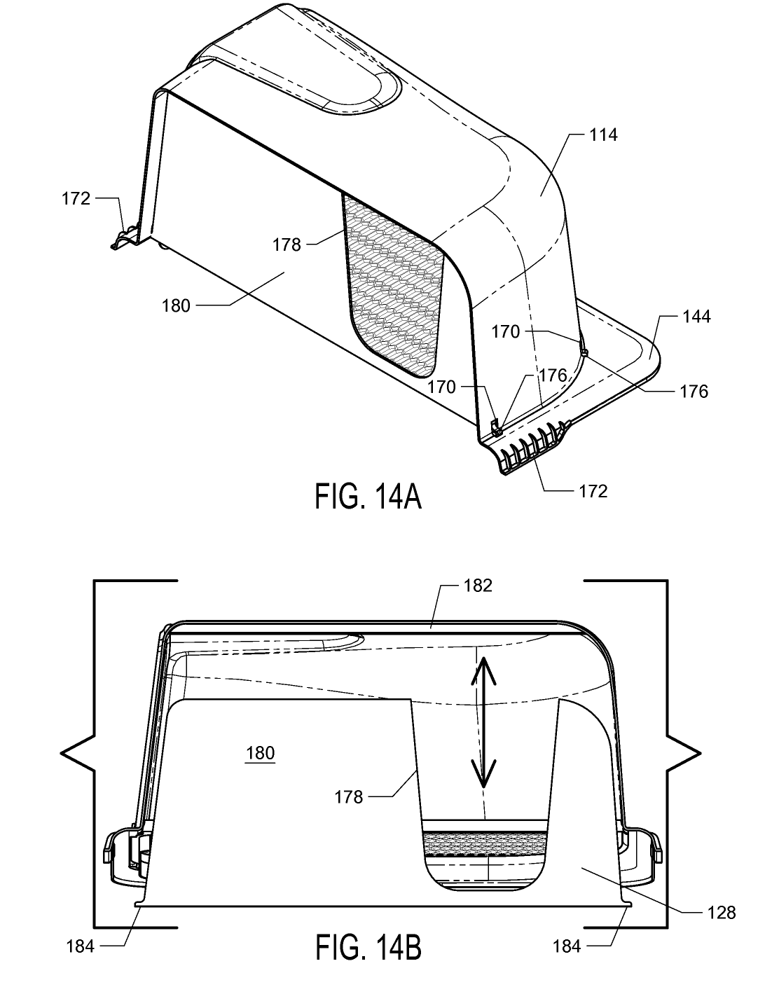

As best shown in FIGS. 14A & 14B, the top side of the dividing wall is received into a slot 182, often tightly, that extends generally front to rear on the inside surface of the upper portion shell's top side 124. A couple of small appendages 184 extend outwardly from the ends of the bottom edge. These appendages are received into the associated rectangular openings 170 adjacent to corresponding outwardly extending appendages 176 of the grate floor frame 116 as can be best seen in FIG. 13B. In combination, the slot and the small appendages secure the dividing wall 180 in place as part of the upper assembly 104 removable from the lower portion shell 102 as a unit.

Numerous variations of the second embodiment pet litter box are contemplated. In at least one variation, the upper assembly is connected to the lower portion shell by way of a hinge on one of the back, left or right sides of the litter box. Accordingly, a user can swing the upper assembly away from the opening of the lower portion shell to access the litter therein. In other variations, the location of the grate floor assembly can vary. For instance, instead of extending from front to back on along one of the left and right sides of the upper assembly, it could extend left to right along the front side of the upper assembly with the upper portion entry door being located proximate one of the left or rights sides and the dividing wall door being located closer to the other of the left and right sides. Other placement variations are possible as well. In some, the location of the entry door can vary as well.

As indicated above the means of attaching the grate floor assembly to the upper portion shell can vary. Additionally the construction of the grate floor assembly can vary as well. In at least one variation, the grate floor comprises a single injection molded piece wherein the grate itself is plastic and co-molded with the surrounding framework.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

We claim:

1. A pet litter box comprising:
a lower portion shell defining a first interior volume having a bottom side, generally upwardly extending lower sidewalls and a lower lip extending around upper edges of the lower sidewalls, the lower portion shell configured to contain and retain a quantity of litter therein; and
an upper assembly, the upper assembly including,
(i) an upper portion shell, the upper portion shell defining a second interior volume having a top side and generally downwardly extending front, back, left and right upper sidewalls, the front upper sidewall including an entrance door, the upper portion shell further including an upper lip extending around bottom edges of the upper sidewalls, the lip configured to mate with the lower lip;
(ii) a grate floor assembly, the grate floor assembly including, a screen floor defining openings that permit particles of litter to fall therethrough, and connectors joining the grate floor assembly directly to the upper portion shell at a location above the upper lip with one edge of the grate floor assembly adjacent to the entrance door, the grate floor extending over only a portion of an area defined by the lower lip;
(iii) a dividing wall, the wall extending upwardly from proximate an open edge of the grate floor assembly to an inside surface of the top side, the dividing wall further including a dividing wall door, the dividing wall door providing entry into the first interior volume.

2. The pet litter box of claim 1, further comprising a storage compartment coupled to the lower portion shell.

3. The pet litter box of claim 1, wherein the upper portion shell further includes a dividing wall slot formed on the inside surface of the top side extending from proximate an intersection with the front upper sidewall to proximate an intersection with the back sidewall, the slot having a top edge of the dividing wall received therein.

4. The pet litter box of claim 1, wherein (a) the upper portion shell includes a plurality of slots spaced around a portion of the sidewalls proximate but above the upper lip, (b) the connectors comprise a plurality of appendages extending outwardly from three sides of the grate floor assembly, and (c) the appendages are received in the slots.

5. The pet litter box of claim 1, wherein the grate floor assembly comprises a grate floor piece and a grate floor frame that extends around the perimeter of the grate floor piece.

6. The pet litter box of claim 5, wherein the grate floor piece comprises an expanded metal screen.

7. The pet litter box of claim 6, wherein the grate floor frame is plastic and the connectors comprise a plurality of grate floor appendages extending outwardly from the grate floor frame.

8. The pet litter box of claim 7, wherein the upper portion shell includes a plurality of slots spaced around a portion of the upper sidewalls proximate but above the upper lip, and wherein the plurality of grate floor appendages are received in the plurality of slots.

9. The pet litter box of claim 6, wherein walls of the grate floor piece that form the openings are slanted off of vertical.

10. The pet litter box of claim 1, wherein a pair of dividing wall appendages extend generally horizontally outwardly from the ends of the dividing wall proximate a bottom edge thereof.

11. The pet litter box of claim 10, wherein the upper portion shell includes at least two opposing slots proximate but above the upper lip, and the dividing wall appendages are received in the opposing slots.

12. The pet litter box of claim 7, wherein a pair of dividing wall appendages extend generally horizontally outwardly from the ends of the dividing wall proximate a bottom edge thereof, and the dividing wall appendages are received in a pair of opposing slots of the plurality of slots next to corresponding grate floor appendages of the plurality of grate floor appendages.

13. The pet litter box of claim 1, wherein the dividing wall door is located at a location in between generally vertically extending edges of the dividing wall but not at either vertically extending edge of the dividing wall.

14. The pet litter box of claim 1 wherein the upper lip includes one or more handles molded therein.

15. A pet litter box comprising:
a lower portion shell defining a first interior volume having a bottom side, generally upwardly extending lower sidewalls and a lower lip extending around upper edges of the lower sidewalls, the lower portion shell configured to contain and retain a quantity of litter therein; and
an upper assembly, the upper assembly including,
(i) an upper portion shell, the upper portion shell defining a second interior volume having a top side and generally downwardly extending front, back, left and right upper sidewalls, the front upper sidewall including an entrance door, the upper portion shell further including (a) an upper lip extending around bottom edges of the upper sidewalls, the upper lip configured to mate with the lower lip, (b) a dividing wall slot formed on an inside surface of the top side extending from proximate an intersection with the front upper sidewall to proximate an intersection with the back upper sidewall, and (c) a plurality of slots spaced around a portion of the upper sidewalls proximate but above the upper lip;
(ii) a grate floor assembly, the grate floor assembly including, an expanded metal screen floor piece having openings to permit particles of litter to fall therethrough, and a grate floor frame that extends around the perimeter of the grate floor piece, the grate floor frame including a plurality of grate floor appendages extending outwardly from three sides thereof and being received in the plurality of slots with one edge of the grate floor assembly adjacent to the entrance door, the grate floor assembly extending over only a portion of an area defined by the lower lip; and
(iii) a dividing wall, the wall extending upwardly from an open edge of the grate floor assembly to the top side of the upper portion shell with the dividing wall slot having a top edge of the dividing wall received therein, the dividing wall further including (1) a dividing wall door, the door providing entry into the first interior volume, the dividing wall door being located at a location in between generally vertically extending edges of the dividing wall but not at either vertically extending edge of the dividing wall, and (2) dividing wall appendages extending generally horizontally outwardly from the ends of the dividing wall proximate a bottom edge thereof, the dividing wall appendages being received in opposing slots of the plurality of slots.

16. The pet litter box of claim 15, wherein walls of the grate floor piece that form the various openings are slanted off of vertical.

17. The pet litter box of claim 15, further comprising a storage compartment coupled to the lower portion shell.

18. The pet litter box of claim 15, wherein the upper lip includes one or more handles molded therein.

19. The pet litter box of claim 15, wherein the dividing wall appendages and corresponding grate floor appendages are received side by side in the opposing slots.
